(19) United States
(12) Patent Application Publication
(10) Pub. No.: US 2013/0119783 A1
(43) Pub. Date: May 16, 2013

(54) CHARGING ELECTRONIC DEVICES

(71) Applicant: Nvidia Corporation, Santa Clara, CA (US)

(72) Inventor: Shuang XU, Shenzhen (CN)

(73) Assignee: NVIDIA CORPORATION, Santa Clara, CA (US)

(21) Appl. No.: 13/675,990

(22) Filed: Nov. 13, 2012

(30) Foreign Application Priority Data
Nov. 14, 2011 (CN) 201110357538.4

(51) Int. Cl. H02J 5/00

(52) U.S. Cl. CPC H02J 5/00
USPC 307/125

(57) ABSTRACT

In one embodiment, a power adapter comprising: an input for coupling to an external power supply; a transformer module for converting the external power supply voltage to a voltage for an electronic device; a relay coupled between the input and the transformer module; a reset switch coupled to the relay for resetting the relay; a detection input for receiving a control signal from the electronic device to control operation of the relay; and an output for outputting the voltage for charging or supplying power to the electronic device, the output coupled to the transformer module and the relay.

### CROSS-REFERENCE TO RELATED APPLICATION

This patent application claims the benefit and priority of the co-pending Chinese Patent Application No. 201110357538.4, filed on Nov. 14, 2011, by Shuang X U, Attorney Docket Number P2011167, which is hereby incorporated by reference in its entirety.

### BACKGROUND

With the increasing popularization of mobile electronic devices such as smart mobile phones and tablet PCs (personal computers) etc., besides the most basic functions such as telephone and short message services, more and more functions which could only be achieved by computers in the past, now can be obtained from these mobile electronic devices, such as browsing web pages, listening to music, watching videos, chatting, writing documents, and so on. All of these functions require the electronic devices to have powerful supplying power in order to guarantee continuing entertainment or work experiences for the users. However, if issues concerning the cost, weight, safety and so on of the battery are involved, the existing battery capacity of mobile electronic devices is usually not enough to meet the use requirement for long operation time. The user needs to connect the electronic device with a power adapter for additional power when the battery has low power. Under the circumstances, however, if the user who connects the electronic device with the power adapter intends to use the mains (or utility power source) to supply power instead of charging the device, the traditional power adapter cannot distinguish such intent and it will still charge the battery automatically. In this way, on one hand, the repeated charging and discharging will result in unnecessary energy waste. On the other hand, it will also reduce the working life of the battery.

Moreover, with respect to the existing power adapter for charging electronic devices such as mobile phones, mobile phone batteries, and tablet PCs and so on, the phenomenon of electricity wasted in vain happens when the power adapter is connected with the power, such as the mains (or utility power source), but without charging the mobile phones or the mobile phones' battery, or when the battery has been fully charged but the power adapter still remains on the power. In particular, regardless of whether the battery has been fully charged, or even the battery has been taken away, the power adapter does consume power when it is connected with the power socket. Accompanied by more and more electronic products used by consumers, energy waste and environment pollution caused by the phenomenon of electricity wasted in vain of the traditional power adapter should seriously be taken into consideration. At the same time, the phenomenon of electricity wasted in vain will also reduce the working life of the battery. Although a reminder signal of charging completion is set up on the power adapter or the electronic products by some producers currently, the users still need to pay certain attention to the reminder signal. Therefore, such reminders can be ignored very easily, and it can also bring inconvenience to the users.

### SUMMARY

Therefore, for overcoming the aforesaid problems or others, an improvement technology for a power adapter and a method for charging need to be provided.

An embodiment in accordance with the present invention provides a power adapter for charging or supplying power for electronic devices. The power adapter comprising: a power input pin connected or coupled with an external power supply; a transformer module for converting the external power supply voltage to the voltage needed by the electronic device for charging or supplying power through the power input pin; a relay connected or coupled between the power input pin and the transformer module for closing or shutting off the current path from the external power input to the transformer module controlled by the input control signals at specific operating conditions; a reset switch connected or coupled to the relay for receiving an external control signal to reset the relay; a detection pin for receiving the control signal from the electronic device to control the operation of the relay; and a power output pin for outputting the voltage converted by the transformer module to the electronic device for charging or supplying power, and the power output pin connected or coupled to the relay for controlling the operation of the relay.

In another embodiment of the present invention, it is provided a method for charging or supplying power for electronic devices through a power adapter. The method comprising the steps of: (a) connecting or coupling the power adapter with an external power supply; (b) detecting whether the power adapter has been connected or coupled to the electronic device, if yes, go to the step (c); if not, returning to the step (a) until the power adapter is connected or coupled to the electronic device; (c) triggering a reset switch for closing a relay for converting the external power supply voltage to the voltage needed by the electronic device; (d) detecting the control signal received by a pin of the power adapter for determining whether the electronic device has been fully charged, if not, returning to the step (c), otherwise go to the step (e); (e) detecting the control signal received by the pin of the power adapter for determining whether the electronic device still needs to be supplied with power, if yes, returning to the step (c), otherwise shutting off the relay.

Preferably, in an embodiment, the external power supply is an alternating current power supply with 110 V (volts) or 220 V.

Preferably, in an embodiment, the voltage output by the transformer module is a direct current power voltage with 3.5 V-5.5 V.

Preferably, in an embodiment, the relay is a magnetic reed relay or a semiconductor relay.

Preferably, in an embodiment, the detection pin and the power output pin connect or couple to the electronic device through an interface.

Preferably, in an embodiment, the interface is any one selected from a group consisting of 30-pin Dock Connector, USB and Micro USB interfaces.

Preferably, in an embodiment, the power adapter further comprises a shell which is made from insulation materials.

Preferably, in an embodiment, the power adapter further comprises an indicator arranged on the shell for indicating the operation status of the power adapter.

Preferably, in an embodiment, the indicator is a LED (light-emitting diode) light or a liquid crystal display.

Preferably, in an embodiment, the electronic device is any one selected from a group consisting of mobile phones, tablet PCs, mobile multimedia devices, and MP3 players.

The power adapter according to an embodiment of the present invention can control the charging time to electronic devices through the electronic devices as wanted by the user, and it can solve the problems that the traditional power adapter cannot distinguish the charging intent of the user. Such power adapter can avoid unnecessary energy waste as well as the bad effects to the working life of the battery caused by the repeated charging and discharging. Besides, an embodiment in accordance with the present invention can completely solve the technology problems of electricity wasted in vain when the battery has not been charged, or it has been fully charged but still remains on the power adapter.

Additional features and advantages of various embodiments in accordance with the invention will be set forth in the description that follows, and in part will be apparent from the description, or may be learned by practice of various embodiments in accordance with the invention. The advantages of various embodiments in accordance with the invention can be realized and attained by the structure particularly pointed out in the written description and claims hereof as well as the appended drawings.

It is to be understood that both the foregoing general description and the following detailed description are exemplary and explanatory and are intended to provide further explanation of various embodiments in accordance with the invention as claimed.

While particular embodiments in accordance with the invention have been specifically described within this Summary, it is noted that the invention and the claimed subject matter are not limited in any way by these embodiments.

### BRIEF DESCRIPTION OF THE DRAWINGS

The accompanying drawings are included to provide a further understanding of various embodiments in accordance with the invention, and are incorporated in and constitute a part of this specification. The drawings illustrate various embodiments of the invention and, together with the description, serve to explain the principles of various embodiments in accordance with the invention. In the drawings,

FIG. 1 illustrates a frame of a power adapter according to an embodiment of the present invention.

FIG. 2 illustrates a schematic frame on connecting or coupling a power adapter according to an embodiment of the present invention with an electronic device.

FIG. 3 illustrates a specific embodiment showing a power adapter according to the invention as a terminal product.

FIG. 4 illustrates a work flow chart of a power adapter according to an embodiment of the present invention.

### DETAILED DESCRIPTION

Reference will now be made in detail to various embodiments in accordance with the invention, examples of which are illustrated in the accompanying drawings. While the invention will be described in conjunction with various embodiments, it will be understood that these various embodiments are not intended to limit the invention. On the contrary, the invention is intended to cover alternatives, modifications and equivalents, which may be included within the scope of the invention as construed according to the Claims. Furthermore, in the following detailed description of various embodiments in accordance with the invention, numerous specific details are set forth in order to provide a thorough understanding of the invention. However, it will be evident to one of ordinary skill in the art that the invention may be practiced without these specific details or with equivalents thereof. In other instances, well known methods, procedures, components, and circuits have not been described in detail as not to unnecessarily obscure aspects of the invention.

Various embodiments in accordance with the present invention relate generally to the electronic devices field and, in particular, to a power adapter and a method for charging electronic devices.

The power adapter according to an embodiment of the present invention can intelligently distinguish the operation of the charging electronic device, such as mobile phones, tablet PCs, mobile multimedia devices, and MP3 players, for charging or supplying power to the electronic devices based on the user's wishes, and it can timely cut off the connection or coupling between the adapter and the mains (or utility power source) input in order to avoid electricity leakage and save energy, when the battery has been fully charged.

The power adapter according to an embodiment of the present invention may be used for interfaces having both data communications and power charging, such as the 30-pin Dock Connector of Apple Inc., USB and Micro USB interfaces, and so on.

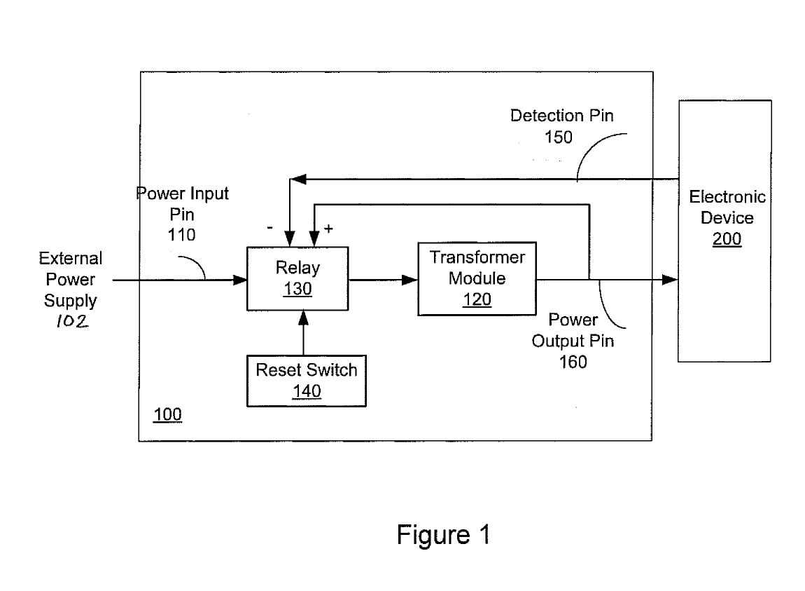

FIG. 1 illustrates a frame of a power adapter 100 according to an embodiment of the present invention. As shown in FIG. 1, a power adapter 100 according to an embodiment of the present invention comprises a power input pin 110 connected or coupled with an external power supply 102, such as the alternating current power mains (or utility power source), namely, an alternating power supply with 110 V or 220 V; a transformer module 120 for converting the input alternating voltage to the direct current (DC) voltage as needed by an electronic device 200 for charging or normal operation, such as the direct current voltage of 5 V; a relay 130 connected or coupled between the power input pin 110 and the transformer module 120 for closing or shutting off the current path from the external power input 102 to the transformer module 120 controlled by input control signals at specific operating conditions; a reset switch 140 connected or coupled to the relay 130 for receiving an external control signal, for example, the user resets the relay 130 through the operation input signal externally; a detection pin 150 connected or coupled to the data/charging interface of the electronic device 200 for receiving the control signal from the electronic device 200 to control the operation of the relay 130; and a power output pin 160 connected or coupled to the transformer module 120 for outputting the direct voltage converted by the transformer module 120 to the electronic device 200 for charging or supplying power, and the power output pin 160 connected or coupled to the relay 130 for controlling operation of the relay 130.

Preferably, in an embodiment, the relay 130 is an alternating current relay, and it can be any type known to those skilled in the art, such as a magnetic reed relay or a semiconductor relay and so on.

The work flow of the power adapter 100 in accordance with an embodiment of the invention is as the following. When the power adapter 100 has no connection or coupling with any electronic device, the detection pin 150 and the power output pin 160 keep floating. The control terminal of the relay 130 has no potential difference, so the relay 130 remains shut off. In this way, even if the power adapter 100 connects or couples to the external alternating current power 102 through the power input pin 110 (not shown in FIG. 1), such as mains (or utility power source) with 220 V, since the relay 130 remains shut off, the inner current path of the power adapter 100 remains shut off too. Therefore, the power adapter 100 will not produce any wasted current in vain or leakage current, and it can save energy.

In an embodiment, when the power adapter 100 is connected or coupled with an external alternating current power 102 through the power input pin 110, and connected or coupled to the electronic device 200 which needs to be charged or supplied with power through the detection pin 150 and the power output pin 160, the user triggers the reset switch 140 and closes the relay 130, namely, to connect or couple the path between the power input pin 110 and the transformer module 120. Then the transformer module 120 starts to work by converting the input alternating current voltage to the direct current voltage as needed by the electronic device 200, such as, in an embodiment, 3.5 V-5.5 V, preferably, in one embodiment, 5 V or 5.1 V. Now the detection pin 150 receives the control signal from the electronic device 200, and such control signal can be produced by instruction from software or operating system of the electronic device 200, and can show the operation status of the electronic device 200. For example, the status is that the user wants to charge the electronic device 200, or the user does not want to charge the electronic device 200 but wants to continually supply power to the electronic device 200 for playing videos and music and so on, or the user wants to charge and continually supply power simultaneously. The software or operating system of the electronic device 200 can send a control signal to the detection pin 150 of the power adapter 100 as needed by the user. Alternatively, such a control signal can also be a status signal automatically sent by the power system of the electronic device 200 itself, such as to show the present remaining electric quantity (or charge) of the battery. If the present remaining electric quantity (or charge) is at a low level, it means that the electronic device 200 needs to be charged; if the battery is at full electric quantity (or charge) and the user still wants to use the electronic device 200, the electronic device 200 needs to be continually supplied with power.

In an embodiment, when the power adapter 100 is needed for charging the electronic device 200, the electronic device 200 will send a low level signal to the detection pin 150 through the software or operating system, which signal level is lower than the direct current voltage level output by the transformer module 120. The relay 130 remains closed in the present situation, and continues to charge the electronic device 200.

In an embodiment, when the battery charging of the electronic device 200 has completed, and the user does not need to continually supply power for the electronic device 200 anymore, the electronic device 200 will send a signal whose level is greater than or equal to the signal level of the direct current voltage output by the transformer module 120 to the detection pin 150 through the software or operating system. Under this circumstance, the relay 130 is activated to be cut off in order to avoid wasting energy and possible battery damage caused by the continuing charge.

In an embodiment, when the battery charging of the electronic device 200 has completed, and the user still needs to continually supply power for the electronic device 200, the electronic device 200 will send a signal whose level is less than the signal level of the direct current voltage output by the transformer module 120 to the detection pin 150 through the user's instructions. Under this circumstance, the relay 130 still remains closed, and the direct current voltage output by the transformer module 120, as a power supply for the electronic device 200, provides the continuing power supply for the electronic device 200.

In an embodiment, when the power adapter 100 is connected or coupled with the external power supply 102 and not connected or coupled to any electronic device, or even if there is a connection or coupling between the power adapter 100 and the electronic device 200 but the user does not need to provide the continuing power supply for the electronic device 200 anymore, if the user triggers the reset switch 140 for closing the relay 130 forcibly, since the detection pin 150 and the power output pin 160 keep floating and thus the control terminal of the relay 130 have no potential difference, the relay 130 will be automatically shut off after a period of time in order to avoid wasting any current in vain and current leakage, such as after 3-5 seconds.

In an embodiment, the detection pin 150 and the power output pin 160 keep floating, and the control terminal of the relay 130 has no potential difference, so the relay 130 remains shut off. In this way, even if the power adapter 100 is connected or coupled to the external alternating current power 102 through the power input pin 110 (not shown in FIG. 1), such as mains (or utility power source) with 220 V, since the relay 130 remains shut off, the inner current path of the power adapter 100 remains shut off too. Therefore, the power adapter 100 will not produce any wasted current in vain or leakage current, which can save energy.

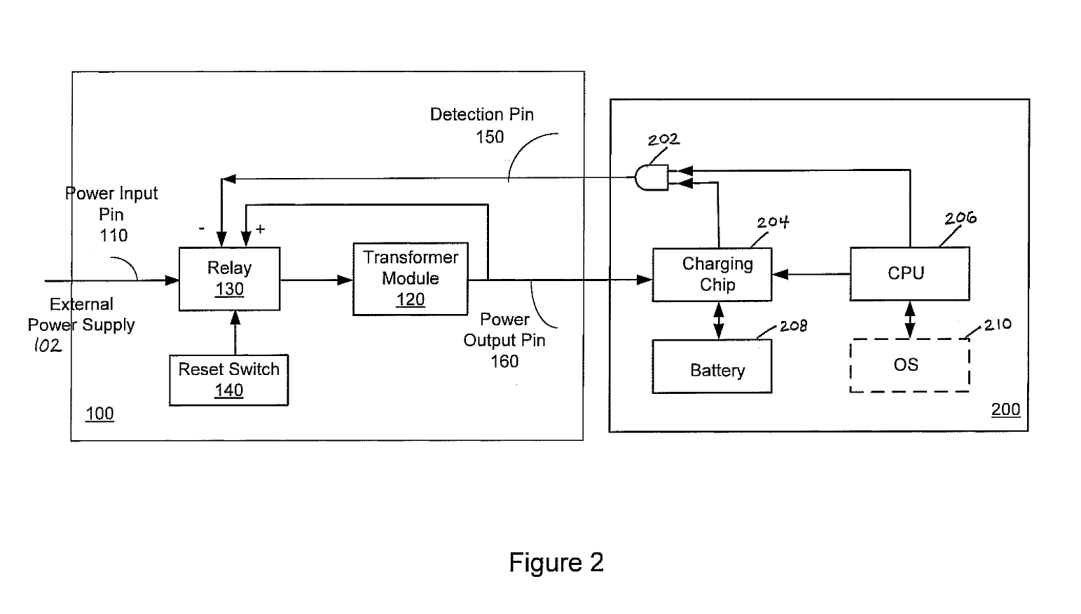

FIG. 2 illustrates a schematic block where the power adapter 100 according to an embodiment of the intention is connected or coupled to an electronic device 200. As shown in FIG. 2, the detection pin 150 receives a signal resulted from an AND operation 202 of the control signal sent by a CPU (central processing unit) 206 from an operating system (OS) 210 of the electronic device 200 and the status signal sent automatically from a power supply system 204 of the electronic device 200 itself. The control signal from the operating system 210 can show the present status of the electronic device 200, for example, the user needs to charge the electronic device 200, the user does not need to charge the electronic device 200 but needs to continually supply power to the electronic device 200 for playing videos and music and so on, or the user needs to charge and continually supply power simultaneously. And the status signal sent automatically from the power supply system 204 of the electronic device 200 itself can show the present remaining electric quantity (or charge) of the battery 208. When the remaining electric quantity (or charge) of the battery 208 is at a low level, it means that the electronic device 200 needs to be charged; if the battery 208 is at full electric quantity (or charge) but the user still needs to use the electronic device 200, it means that the electronic device 200 needs to be power-supplied continually.

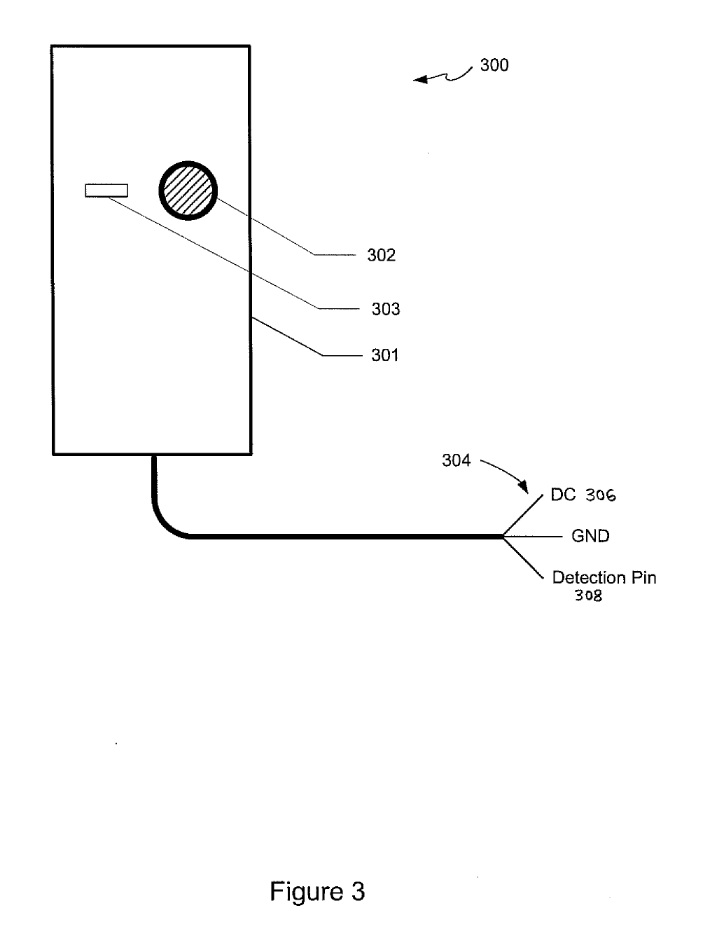

FIG. 3 illustrates a specific embodiment showing a power adapter 300 according to the invention as a terminal product.

As shown in FIG. 3, the power adapter 300 comprises a shell 301 which can be made of insulation materials such as PE (polyethylene) plastic or porcelain etc.; a reset switch 302, connected or coupled to the relay 130 for receiving an external control signal from the user to reset the relay 130; and output interfaces 304 which comprise a detection pin 308 and a power output pin 306, the detection pin 308 being connected or coupled to the data/charging interface of the electronic device 200 for receiving the control signal from the electronic device 200 to control the operation of the relay 130; and the power output pin 306 connected or coupled to the transformer module 120 for outputting the direct current (DC) voltage converted by the transformer module 120 to the electronic device 200 for charging or supplying power, and the power output pin 306 connected or coupled to the inner relay 130 for controlling the operation of the relay 130.

According to one embodiment of the invention, the power adapter 300 may comprise an indicator 303 arranged on the shell 301 for indicating the existing status of the power adapter 300. In an embodiment, the indicator 303 may be a LED (light-emitting diode) indicating light and it may show the different statuses of the power adapter 300 by showing different colors. For example, in an embodiment, the LED light showing green indicates that the power adapter 300 is turned on and working, namely, charging or supplying power for the electronic device 200; whereas the LED light showing red indicates that the power adapter 300 is shut off and does not work. Alternatively, in an embodiment, a liquid crystal display also can be substituted for the LED light, and the status of the power adapter 300 can be showed by any way such as the characters and the signs as known to those skilled in the art.

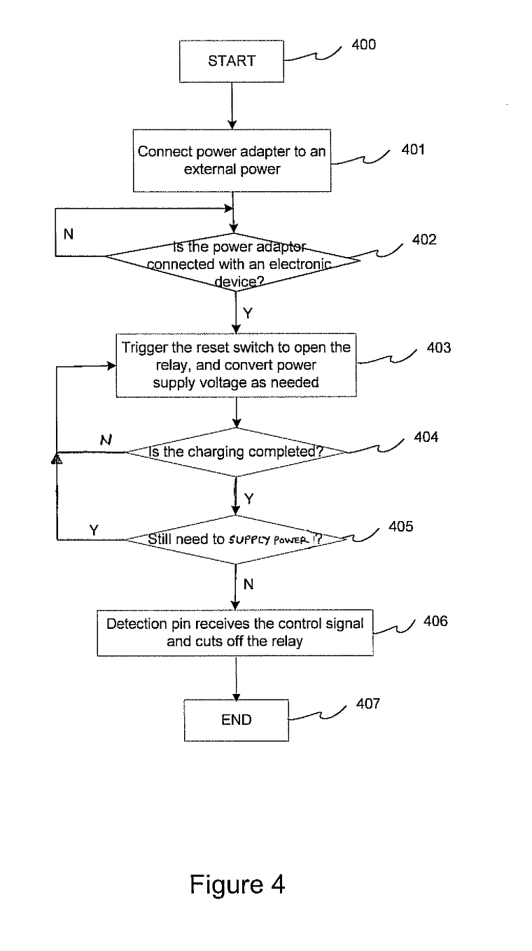

FIG. 4 illustrates a work flow chart of a power adapter according to an embodiment of the present invention. As shown in FIG. 4, the work flow of the power adapter according to an embodiment of the present invention starts from step 400.

At step 401, the power adapter is connected or coupled to an external power.

At step 402, detecting whether the power adapter has been connected or coupled to an electronic device. If not, returning until the power adapter is connected or coupled to an electronic device; otherwise, go to step 403.

At step 403, a user triggers a reset switch to close a relay, and then a transformer module starts to work converting the external alternating current power supply voltage to the direct voltage as needed by the electronic device.

At 404, detecting the control signal received by a pin for determining whether the electronic device has been fully charged. If not, returning to step 403 for continuing to supply power; otherwise, go to step 405.

At step 405, detecting the control signal received by the pin for determining whether the electronic device still needs to be supplied power. If yes, returning to step 403 for continuing to supply power; otherwise, go to step 406.

At step 406, the detection pin receives the control signal and shuts off the relay.

At step 407, the work flow ends.

The power adapter and method for charging provided by an embodiment of the invention is used for preventing electricity from being wasted in vain in an uncharged state. It can automatically detect the charging state of the battery. When the battery of the electronic device has been fully charged or taken away from the adapter, the power input can be automatically cut off in order to save energy and prolong the working life of the power adapter. It can solve the problem of wasting electricity in vain when the battery is not charged or has been fully charged but still remains on the power supply.

Besides, in an embodiment, under the control of the inner circuit of the electronic device, the power adapter may determine whether to charge according to the users' wishes. It also renders flexibility for the power adapter and the method for charging of an embodiment of the invention, and avoids the unnecessary energy waste as well as the bad effects caused by the repeated charging and supplying power to the working life of the battery.

It should be appreciated that various modifications, adaptations and alternative embodiments thereof may be made within the scope and spirit of the present invention. The invention is further defined by the following claims.

The foregoing descriptions of various specific embodiments in accordance with the invention have been presented for purposes of illustration and description. They are not intended to be exhaustive or to limit the invention to the precise forms disclosed, and many modifications and variations are possible in light of the above teaching. The invention is to be construed according to the Claims and their equivalents.

What is claimed is:

1. A power adapter comprising:
an input for coupling to an external power supply;
a transformer module for converting the external power supply voltage to a voltage for an electronic device;
a relay coupled between the input and the transformer module;
a reset switch coupled to the relay for resetting the relay;
a detection input for receiving a control signal from the electronic device to control operation of the relay; and
an output for outputting the voltage for charging or supplying power to the electronic device, the output coupled to the transformer module and the relay.

2. The power adapter of claim 1, wherein the external power supply comprises an alternating current power supply.

3. The power adapter of claim 1, wherein the voltage output by the transformer module is a direct current power voltage.

4. The power adapter of claim 1, wherein the relay is a magnetic reed relay or a semiconductor relay.

5. The power adapter of claim 1, wherein the detection input and the output are coupled to the electronic device through an interface.

6. The power adapter of claim 5, wherein the interface is selected from a group consisted of a 30-pin Dock Connector, USB and Micro USB interfaces.

7. The power adapter of claim 1, wherein the power adapter further comprises an indicator for indicating an operation status of the power adapter.

8. The power adapter of claim 7, wherein the indicator comprises a light emitting diode (LED).

9. The power adapter of claim 7, wherein the indicator comprises a liquid crystal display.

10. The power adapter of claim 1, wherein the electronic device is selected from a group consisting of a mobile phone, a tablet personal computer, a mobile multimedia device, and a MP3 player.

11. A method comprising:
coupling a power adapter with an external power supply;
detecting whether the power adapter has been coupled to an electronic device;
triggering a reset switch for closing a relay of the power adapter for converting the external power supply voltage to a voltage for an electronic device;
determining whether the electronic device has been fully charged;
determining whether the electronic device is to be supplied with power;
if the electronic device is not to be supplied with power, shutting off the relay.

12. The method of claim 11, wherein the external power supply is an alternating current power supply.

13. The method of claim 11, wherein the voltage is a direct current power voltage.

14. The method of claim 11, wherein the relay is a magnetic reed relay or a semiconductor relay.

15. The method of claim 11, wherein the electronic device is selected from a group consisting of a mobile phone, a tablet personal computer, a mobile multimedia device, and a MP3 player.

16. A power adapter comprising an input for coupling to an external power supply;
a transformer module for converting the external power supply voltage to a direct current power voltage for an electronic device;
a semiconductor relay coupled between the input and the transformer module;
a reset switch coupled to the semiconductor relay for resetting the relay;
a detection input for receiving a control signal from the electronic device to control operation of the semiconductor relay; and
an output for outputting the direct current power voltage for charging or supplying power to the electronic device, the output coupled to the transformer module and the semiconductor relay.

17. The power adapter of claim 16, wherein the external power supply comprises an alternating current power supply.

18. The power adapter of claim 16, wherein the power adapter further comprises an indicator for indicating an operation status of the power adapter.

19. The power adapter of claim 18, wherein the indicator is a light emitting diode (LED) or a liquid crystal display.

20. The power adapter of claim 16, wherein the electronic device is selected from a group consisting of a mobile phone, a tablet personal computer, a mobile multimedia device, and a MP3 player.
